(19) United States
(12) Patent Application Publication
(10) Pub. No.: US 2023/0073149 A1
(43) Pub. Date: Mar. 9, 2023

(54) NOZZLE ASSEMBLY WITH TARGETED SPRAY DISTRIBUTION

(71) Applicant: Tyco Fire Products LP, Lansdale, PA (US)

(72) Inventor: Karl Maas, JR., Peshtigo, WI (US)

(73) Assignee: Tyco Fire Products LP, Lansdale, PA (US)

(21) Appl. No.: 17/800,365

(22) PCT Filed: Feb. 25, 2021
(86) PCT No.: PCT/IB2021/051580

§ 371 Date: Aug. 17, 2022

Related U.S. Application Data
(60) Provisional application No. 62/983,123, filed on Feb. 28, 2020.

(51) Int. Cl. A62C 31/05; B05B 1/04; B05B 1/14; B05B 1/26; B05B 1/34; B05B 15/625; B05B 15/65

(52) U.S. Cl. CPC A62C 31/05; B05B 1/046; B05B 1/14; B05B 1/267; B05B 1/34; B05B 15/625; B05B 15/65

(57) ABSTRACT

A grate assembly includes a grate and a nozzle. The grate includes a nozzle aperture. The nozzle is received by the nozzle aperture. The nozzle includes a base and a baffle coupled to the base. The base and the baffle define a plurality of flow paths. The nozzle also includes a deflector ring removably positioned between the baffle and the base. The deflector ring includes a body that defines a spray outlet, wherein the body allows fluid flow through one or more flow paths aligned with the spray outlet and prevents fluid flow through the remaining flow.

### CROSS-REFERENCE TO RELATED PATENT APPLICATION

This application claims the benefit of and priority to U.S. Patent Application No. 62/983,123, filed Feb. 28, 2020, the entire disclosure of which is hereby incorporated by reference herein.

### BACKGROUND

Fire suppression systems, such as for use in buildings, can include a nozzle positioned within or along a floor (e.g., as part of a trench, a drain, a grate, etc.). The nozzle can provide fire suppression agent to an area (e.g., within a relatively large open space such as an aircraft hangar, etc.). The nozzle may be configured to direct fire suppression agent in a desired direction or over a desired spray distribution.

### SUMMARY

One aspect of the present disclosure relates to a grate assembly. The grate assembly includes a grate and a nozzle. The grate includes a nozzle aperture. The nozzle is received into the nozzle aperture of the grate. The nozzle includes a base, and a baffle coupled to the base. The base and the baffle define a plurality of flow paths. The also includes a deflector ring positioned between the baffle and the base. The deflector ring includes a body that defines a spray outlet, wherein the body allows fluid flow through one or more flow paths aligned with the spray outlet and prevents fluid flow through the remaining flow paths.

In various embodiments, the deflector ring defines a spray angle of the nozzle. In some embodiments, the spray angle is one of 90 degrees, 180 degrees, or 270 degrees. In other embodiments, the nozzle is received at a top side of the grate, and the deflector ring is replaceable when the nozzle is coupled to the grate by accessing only the top side of the grate. In some embodiments, the deflector ring is moveable relative to a central axis of the nozzle when the nozzle is coupled to the grate by accessing a fastener on the top side of the baffle. In various embodiments, the base includes a plurality of flow protrusions defining the plurality of flow paths. In some embodiments, the plurality of flow protrusions are spaced about a circumference of the base. In other embodiments, the deflector ring includes an annular projection received in an annular groove of the base.

Another aspect of the present disclosure relates to a nozzle. The nozzle includes a base, and a baffle coupled to the base. The base and the baffle define a plurality of flow paths. The nozzle also includes a deflector ring positioned between the baffle and the base. The deflector ring includes a body that defines a spray outlet, wherein the body allows fluid flow through one or more flow paths aligned with the spray outlet and prevents fluid flow through the remaining flow paths.

In various embodiments, the spray outlet defines a spray angle. In some embodiments, the spray angle is one of 90 degrees, 180 degrees, or 270 degrees. In other embodiments, the deflector ring is replaceable by accessing only a top side of the nozzle assembly. In yet other embodiments, the deflector ring is moveable relative to a central axis by accessing a fastener on the top side of the nozzle assembly. In various embodiments, the base includes a plurality of flow protrusions, the plurality of flow protrusions defining the plurality of flow paths. In some embodiments, the plurality of flow protrusions are spaced about a circumference of the base. In other embodiments, the deflector ring includes an annular projection received in an annular groove of the base.

Another aspect of the present disclosure relates to a grate kit assembly. The grate assembly kit includes a grate, a nozzle, and a plurality of deflector rings. The grate defines a nozzle aperture. The nozzle is configured to be positioned within the nozzle aperture. The plurality of deflector rings are each removably and individually positioned within the nozzle. Each deflector ring of the plurality of deflector rings includes a body that defines a spray outlet, and wherein the body allows fluid flow through a first subset of the plurality of flow paths and prevents fluid flow through a second subset of the plurality of flow paths.

In various embodiments, the plurality of deflector rings includes a first deflector ring configured to provide a 90 degree spray pattern and a second deflector ring configured to provide a 180 degree spray pattern. In some embodiments, the nozzle includes a base and a baffle coupled to the base, the base and the baffle defining a plurality of flow paths. In other embodiments, each deflector ring prevents fluid flow through at least one flow path of the plurality of flow paths to provide the spray pattern for the nozzle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic illustration of a fire suppression system, according to an exemplary embodiment.

FIG. 2 is an exploded perspective view of a grate assembly for use with the fire suppression system of FIG. 1, according to an exemplary embodiment.

FIG. 3 is an exploded perspective view of a nozzle for use in the grate assembly of FIG. 2, according to an exemplary embodiment.

FIG. 4 is a partial section view of a grate for use in the grate assembly of FIG. 2, according to an exemplary embodiment.

FIG. 5 is a partial section view of a base of the nozzle of FIG. 3, according to an exemplary embodiment.

FIG. 6 is a perspective view of the base of FIG. 5, according to an exemplary embodiment.

FIG. 7 is a partial section view of a baffle for the nozzle of FIG. 3, according to an exemplary embodiment.

FIG. 8 is a perspective view of the baffle of FIG. 7, according to an exemplary embodiment.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates generally to the field of fire suppression. Fire suppression systems can output a fire suppression agent, such as a foam, to respond to a fire condition. Fire suppression systems can output the fire suppression agent responsive to detecting the fire condition. Fire suppression systems can be activated manually or automatically in response to an indication that a fire is present nearby (e.g., an increase in ambient temperature beyond a predetermined threshold value). For example, fire suppression systems can include a fire detector that detects the fire condition and provides a fire detection signal to a controller. The controller can cause the fire suppression agent to be delivered from a storage tank to an area of the fire condition, such as through one or more nozzles. The fire suppression system can spread the fire suppression agent through the area, to extinguish the fire or prevent growth of the fire.

Certain areas (e.g., airplane hangars, paper mills, chemical processing plants, etc.) commonly having combustible fluid near heated material. The combination of large open areas containing large quantities of combustible fluid and the proximity of heated material can cause fires to occur. Fire suppression systems can be installed in the open areas to suppress such fires. Many of the open areas have the possibility of widespread and dangerous fires occurring. The fires can be too dangerous (e.g., hot, volatile, etc.) for a person to approach with a smaller fire suppression system (e.g., handheld extinguishers, etc.). Fire suppression systems able to supply large quantities of fire suppression agent to a hazard area in a short period are implemented in such applications.

Various embodiments disclosed herein are directed to fire suppression systems that utilize a nozzle (e.g., a trench nozzle, a grate nozzle, etc.) configured to provide fire suppression agent over an area. The nozzle directs a spray of fire suppression agent over a spray area within the area. Multiple nozzles can be positioned within the area. Each nozzle can be positioned within a grate covering a drain system of the area and be coupled to the grate (e.g., via a clamp, fastener, etc.). Rotation of the nozzle relative to the grate may be limited or prevented. The nozzle is configured to distribute the fire suppression agent over an angular spray pattern (e.g., about an area ranging from 90 degrees-360 degrees, although narrow angular ranges may be utilized in various alternative embodiments). A blocking mechanism may be included in the nozzle to limit spray of the fire suppression agent to a specified angle. The blocking mechanism allows changing of a spray area from a first angle to a second different angle without loosening or removing of the clamp. The spray area can be changed via top access of the nozzle and changing of the blocking mechanism.

According to various embodiments, a nozzle can be manufactured and various deflector rings can be selectively and individually positioned within the nozzle to define an angle of spray. Each deflector ring defines a different spray angle. The nozzle can be positioned within a building (e.g., near a wall, in a corner, in a center of the building, etc.) and an appropriate deflector ring can be provided to each nozzle based on the position of the nozzle.

Referring generally to the figures, a nozzle assembly (e.g., a grate nozzle assembly, a grate assembly, etc.) is depicted, according to one embodiment. The grate nozzle assembly includes a nozzle, a grate, and a deflector ring. The nozzle includes a base and a baffle. The base and the baffle are coupled via a fastener. When coupled, the base and the baffle define flow paths to direct the flow of a fire suppression agent through the flow paths. The base and baffle further define an annular cavity configured to accept the deflector ring to restrict flow of the fire suppression agent to certain the flow paths, thereby providing a desired angular spray pattern for the fire suppression agent rather than a full 360 degree spray pattern.

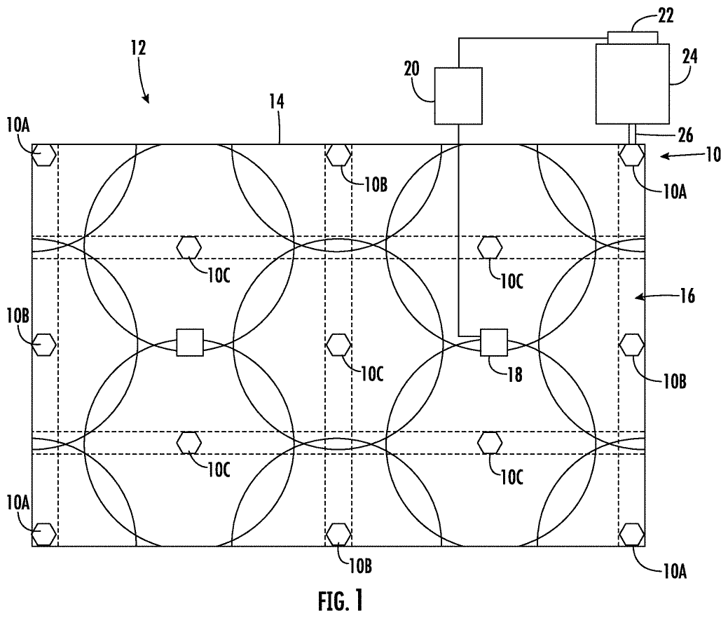

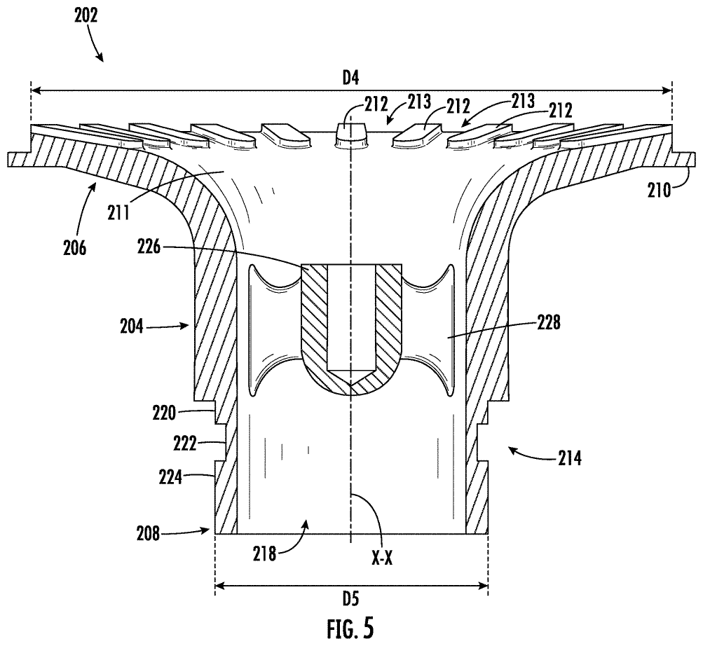

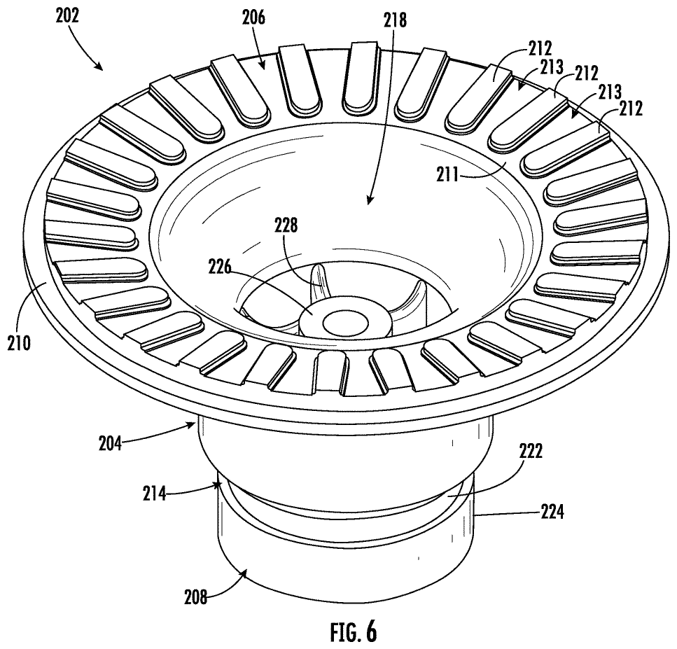

Referring now to FIG. 1-8, components of a grate nozzle assembly 10 are depicted according to various embodiments. The grate nozzle assembly 10 is positioned within a building 12. Specifically, in a large open space, room, or area 14 (e.g., an airplane hangar, etc.). The grate nozzle assembly 10 may be provided within or on a floor of area 14, for example, in a drain system 16 of the area. The grate nozzle assembly 10 includes multiple grate nozzle assemblies 10A, 10B, and 10C, which may be positioned in the area 14 and directed towards hazard or other areas of the area 14 (e.g., fuel containers, aircrafts, etc.). Fire suppression agent is released through at least one of the grate nozzle assemblies 10A, 10B, or 10C if a fire is detected within the area 14. The area 14 may be provided with at least one detection device 18 (e.g., smoke detectors, heat detectors, optical detectors, etc.). In one embodiment, the detection devices 18 detect a condition relating to a fire occurrence and send a signal corresponding to the detection to a controller 20. The controller 20 may be within the area 14, or may be remote from the area 14. The controller 20 sends a signal to an actuation device 22 to release the fire suppression agent from a tank 24 of fire suppression agent. The fire suppression agent flows from the tank 24 to the grate nozzle assembly 10 via a conduit or piping 26. The piping 26 may also be positioned within the drain system 16.

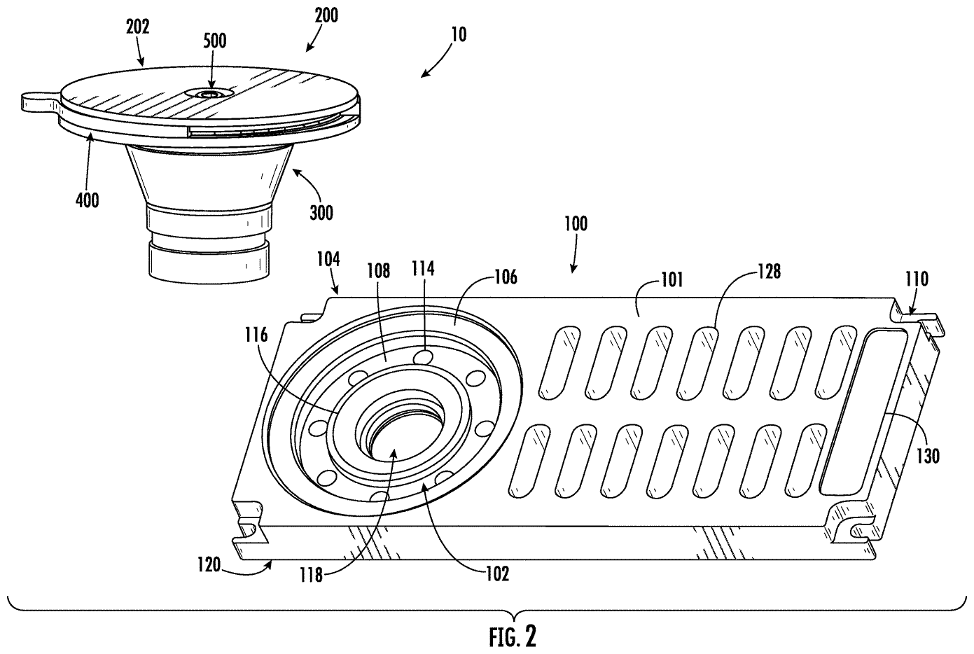

Referring to FIG. 2, the grate nozzle assembly 10 is shown according to an exemplary embodiment. The grate nozzle assembly 10 (e.g., similar or equivalent to grate nozzle assembly 10A, 10B, or 10C), as shown in FIG. 2, includes a grate 100 and a nozzle 200. The nozzle 200 is received by grate 100 such that, if desired, the grate nozzle assembly 10 may be installed as a single unit. The grate 100 defines a body 101. The body 101 interfaces with the drain system 16 in the floor of the area 14. One or more slots 110 (e.g., mounting slots, channels, recesses, etc.) are defined by the body 101 of the grate 100 to facilitate positioning of the grate 100 within the drain system 16. The slots 110 may interface with a protrusion or a fastener within the drain system 16 to orient, position, and secure the grate 100 to a gap within the drain system 16. The body 101 defines one or more drain apertures 128. The drain apertures 128 facilitate the passage of fluid through the grate 100 and into the drain system 16 to enable normal operation of the drain system 16. The body 101 may also define an interface recess 130. The interface recess 130 may facilitate a user interfacing with the grate 100 to move or orient the grate 100. The grate 100 defines a nozzle recess 102. The nozzle recess 102 interfaces and accepts at least a portion of the nozzle 200. The nozzle recess 102 is positioned on a first side 104 of the grate 100. The nozzle recess 102 is sized similarly to an outer diameter of the nozzle 200. A seal may be positioned within the nozzle recess 102 to form a fluid seal with the nozzle 200. The nozzle recess 102 includes a first grate step 106. The first grate step 106 defines a largest diameter of the nozzle recess 102. The first grate step 106 also defines a minimum depth of the nozzle recess 102. The nozzle recess 102 includes a second grate step 108. The first grate step 106 may be tapered from a portion of the second grate step 108 to a surface of the grate 100. One or more drain apertures 114 may be defined through a surface of the second grate step 108. The drain apertures 114 are positioned in a radial pattern around a center of nozzle recess 102. In some embodiments, the drain apertures 114 may be tapered or tapped holes to accept a head and/or body of a fastener. The nozzle recess 102 also includes a third grate step 116. The third grate step 116 may have a diameter smaller than at least one of the first grate step 106 and the second grate step 108. The third grate step 116 may be positioned radially inward of the drain apertures 114. The third grate step 116 may be raised relative to the second grate step 108.

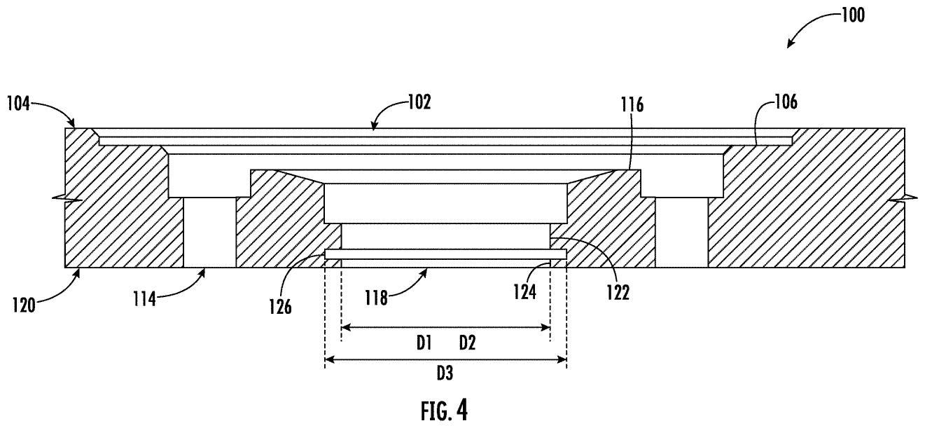

The grate 100 also defines a nozzle aperture 118. The nozzle aperture 118 extends from a surface of the nozzle recess 102 (e.g., the first grate step 106, the second grate step 108, the third grate step 116, etc.) to a second side 120 of the grate 100. The third grate step 116 defines a taper extending from the second grate step 108 to the nozzle aperture 118. The nozzle aperture 118 is configured to accept a portion of the nozzle 200. The nozzle aperture 118 includes a first annular section 122 having a first diameter D1. The nozzle aperture 118 includes a second annular section 124 having a second diameter D2. The nozzle aperture 118 includes a third annular section 126 having a third diameter D3. The first annular section 122 may be positioned closer to the top surface of the grate 100 than the second annular section 124 or the third annular section 126. Although FIG. 4 shows D1 being substantially the same as D2, in various embodiments, D1 may be larger than D2 and/or D3. As shown, the second annular section 124 extends from the first annular section 122 to the bottom surface of the grate 100. The third annular section 126 is located along the second annular section 124, between the bottom surface of the grate 100 and the first annular section 122. In various embodiments, D3 may be the same as or larger than D2. In some embodiments, the third annular section 126 may accept a seal (e.g., an O-ring, etc.) to interface with the nozzle 200.

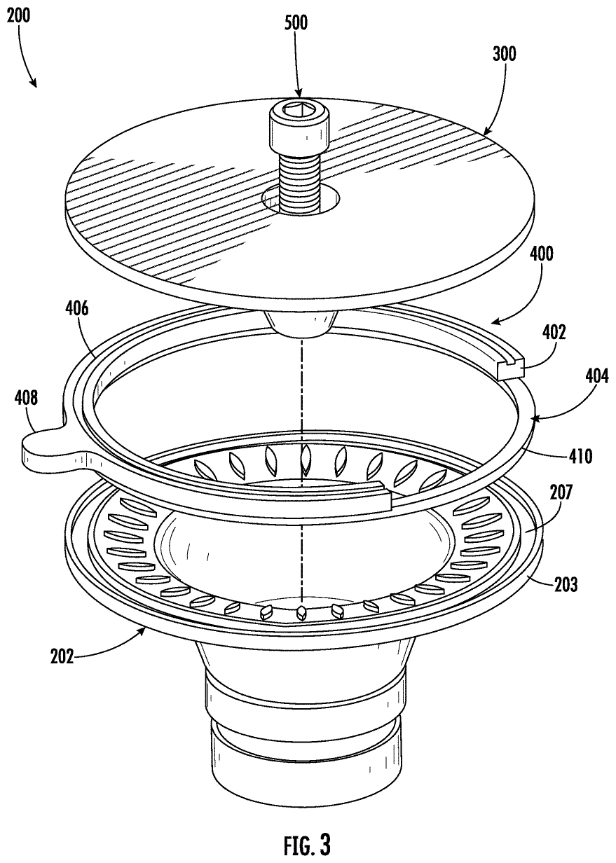

Referring to FIGS. 3-8, the nozzle 200 is shown greater detail according to one embodiment. The nozzle 200 can disperse a quantity of fire suppression agent throughout a spray area. The spray area may be directed towards a hazard (e.g., fuel storage, aircraft, etc.). The nozzle 200 interfaces with the nozzle recess 102 and the nozzle aperture 118 of the grate 100. The nozzle 200 is oriented relative to the grate 100 to direct the release of fire suppression agent. The nozzle 200 receives fire suppression agent from the tank and directs the fire suppression agent toward the hazard. The nozzle 200 includes a base 202, a baffle 300, and a deflector ring or blocking structure 400. The base 202 interfaces with the grate 100. The baffle 300 interfaces with the base 202 to define flow paths 213. The deflector ring 400 limits flow of fire suppression agent from the nozzle 200 by allowing flow through a first subset of the one or more of the flow paths 213 and preventing flow through a second subset of the one or more flow paths 213 to provide an angular distribution of fire suppression agent (e.g., a 90 degree spray pattern, a 180 degree spray pattern, a 270 degree spray pattern.

The base 202 includes a base body 204. The base body 204 may be radially symmetric around a base axis X-X. The base body 204 includes a first end 206 and a second end 208. The first end 206 is opposite the second end 208. The first end 206 has a diameter D4. The second end 208 has a diameter D5. The diameter D4 of the first end 206 may be larger than the diameter D5 of the second end 208. The first end 206 includes a flange 210. The flange 210 may be monolithic with the remainder of the base body 204. The flange 210 extends radially outward relative to the base axis X-X. The first end 206 of the base body 204 includes flow protrusions 212 (e.g., pads, etc.) that extend outward from an interior surface 211 of the base body 204. The flow protrusions 212 are arranged in a radial pattern relative to the base axis X-X. The flow protrusions 212 extend away from the second end 208. Each flow protrusion 212 is spaced apart from the adjacent flow protrusions 212. The base body 204 defines a base groove 214. The base groove 214 is positioned between the first end 206 and the second end 208. The base groove 214 can extend below the second side 120 of the grate 100 and interface with the clamp, as described above. The base groove 214 includes a first base step 220, a second base step 222, and a third base step 224. The base groove 214 may also interface with the piping 26. The first base step 220 is closer to the base axis X-X relative to an outer surface of the base 202. The second base step 222 is closer to the base axis X-X relative to the first base step 220. The third base step 224 is further from the base axis X-X relative to the second base step 222. In various embodiments, the third base step 224 and the first base step 220 may be the same distance from the base axis X-X.

The interior surface 211 of the base body 204 defines a passageway 218. The passageway 218 extends from the first end 206 to the second end 208. The passageway 218 facilitates flow of fire suppression agent from the second end 208 to the first end 206. The passageway 218 is tapered along at least a portion of the base body 204. For example, the passageway 218 has a larger diameter at the first end 206 than the second end 208. The base body 204 may also include a central body 226. The central body 226 has a rounded end. The central body 226 is also hollow. The hollow central body 226 can include grooves to facilitate coupling to a fastener. Arms 228 are coupled the central body 226 to the passageway 218. The arms 228 form flow patterns for the fire suppression agent flow between the arms 228.

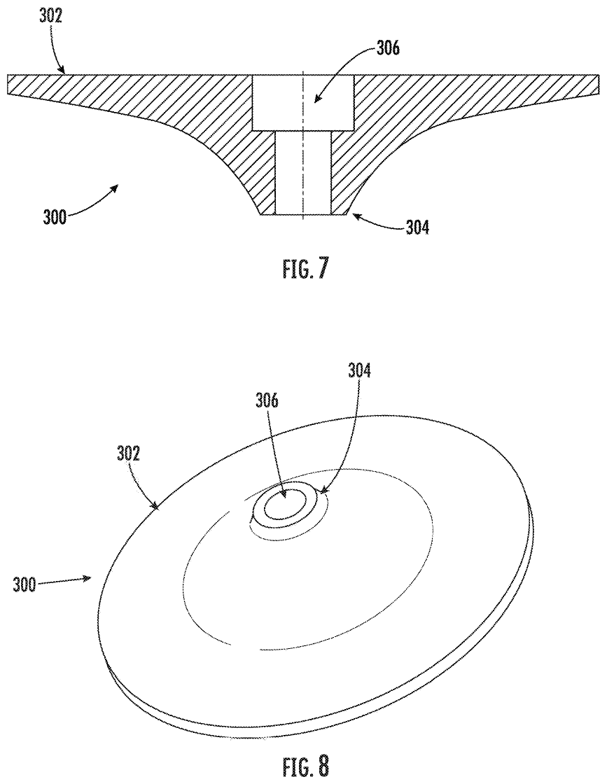

Referring now to FIGS. 7 and 8, the baffle 300 is shown in greater detail, according to one embodiment. The baffle 300 can be removably coupled to the base 202. The baffle 300 interfaces with the base 202 to define at least one flow path 213 for the fire suppression agent to flow through. The baffle 300 includes a top 302 and a bottom 304. The baffle 300 is tapered, such that the top 302 can be larger than the bottom 304. The taper of the baffle 300 can be similar to the taper of the interior surface 211, which defines the passageway 218. The bottom 304 can be smaller than at least a portion of the passageway 218, such that the end portion of the bottom 304 can be accepted by the passageway 218. The top 302 can be similar or larger than the first end 206 of the base 202. The tapered surface of the bottom 304 interfaces with the flow protrusions 212 to define flow paths 213, where each flow path 213 is defined between two adjacent flow protrusions 212, the bottom 304 and the interior surface 211, which the flow protrusions 212 extend from. A cavity is defined between the flange 210 of the base 202 and the baffle 300. The baffle 300 also defines a baffle fastener aperture 306. The baffle fastener aperture 306 extends from the top 302 to the bottom 304.

Referring again to FIG. 3, the deflector ring 400 is shown in greater detail according to one embodiment. The deflector ring 400 limits or prevents flow of fire suppression agent through at least a portion of the nozzle 200. Specifically, the deflector ring 400 inhibits flow from certain predetermined flow paths 213. The predetermined flow paths 213 are along one or more arcs (e.g., 90 degrees, 180 degrees, 270 degrees, etc.). In other words, the deflector ring 400 permits flow through a first subset of the flow paths 213 and prevents flow from a second subset of the flow paths 213, wherein the second subset of the flow paths 213 are disposed along one or more arcs (i.e., along the interior surface 211 of the nozzle 200). The deflector ring 400 has an annular body 402. The annular body 402 interfaces with an outer perimeter of a bottom surface of the bottom 304 of the baffle 300, and with the flange 210 of the base 202. In some example, the base 202 includes an outer wall 203 (see FIG. 3) on the flange 210, which defines a cavity 207 (e.g., a groove, channel, recess, etc.) that receives at least a portion of the deflector ring 400. In some embodiments, the deflector ring 400 includes a bottom rail 410 (e.g., a projection, etc.) received by the cavity 207. The bottom rail 410 may have a smaller width than the annular body 402. The annular body 402 has a portion omitted to define a gap or spray outlet 404. The bottom rail 410 may extend along an entire perimeter of the deflector ring 400 or may be omitted with the annular body 402 along the spray outlet 404. The spray outlet 404 allows fire suppression agent to flow through a plurality of the flow paths 213 (i.e., the plurality of flow paths 213 aligned with the spray outlet 404). The spray outlet 404 is manufactured to be a specific dimension to allow fire suppression agent to be dispersed at a specific angular range from the nozzle 200. Each deflector ring 400 allows release of fire suppression agent along a specific angle (e.g., 90 degrees, 180 degrees, etc.) defined by the spray outlet 404. Accordingly, the deflector ring 400 allows release of fire suppression agent from a first subset of the flow paths 213 aligned with the spray outlet 404 (which defines a specific spray angle) and prevent release of fire suppression agent from a second subset of the flow paths 213 that are not aligned with the spray outlet 404 and are blocked by the annular body 402. For example, depending on the number of protrusions 212 and flow paths 213, the spray outlet 404 allows eight flow paths 213 to release fire suppressant agent in an arc of 90 degrees with the remaining flow paths 213 blocked by the annular body 402 so that those remaining flow paths do not release fire suppressant agent from the nozzle 200. In alternative embodiments, the deflector ring 400 includes multiple spray outlets 404 in the annual body 402 to provide multiple spray outlets (e.g., two 90 degree arcs located opposite one another. In other embodiments the deflector ring 400 can also be omitted from a nozzle 200 to allow fire suppression agent to be released from all flow paths 213 (e.g., 360 degrees). In some exemplary uses, a manufacturer can produce multiple nozzles 200 and each of those nozzles 200 can be provided with different blocking structures or deflector rings 400 that are individually couplable to the nozzle 200 to allow each nozzle's spray pattern to be customized to that nozzle's particular location and role in the overall spray pattern for an area 14 as shown in FIG. 1. As shown in FIG. 1, a spray pattern that covers the rectangular area 14 is created with four nozzle assemblies 10A equipped with a deflector ring 400 providing a 90 degree output, four nozzle assemblies 10B equipped with a deflector ring 400 providing a 180 degree output, and five nozzle assemblies 10C equipped with no deflector ring 400 for a 360 degree output. The 90 degree output nozzle assemblies 10A are positioned with one in each corner of the area 14. The 180 degree output nozzle assemblies 10B are positioned one to each side of the rectangle with each nozzle assembly 10B located between (e.g., halfway between) two of the 90 degree output nozzle assemblies 10A. The 360 degree output nozzle assemblies 10C are positioned within the area 14 (i.e., spaced apart from the corners and sides of the area 14). The use of different types of nozzle assemblies (as determined by whether and what type of deflector ring 400 is used) allows for a fire suppression system in which the overall spray coverage of fire suppression agent (as shown by the circles or portions of circles originating from the nozzle assemblies 10A, 10B, and 10C) covers the area 14, with minimal overlap and without directing fire suppression agent toward the sides or corners of the area 14. Fire suppression agent directed to the sides or corners of the area 14 is wasted or put to less efficient use than fire suppression agent directed within the area 14.

The deflector ring 400 includes a deflector ring groove 406. The deflector ring groove 406 can be provided with a seal (e.g., an O-ring, etc.) to form a fluid seal along the annular body 402. The deflector ring 400 includes a tab 408. The tab 408 may assist a user to rotate the deflector ring 400 relative to the base 202, and/or may assist a user in installation or removal of the deflector ring 400 from the base 202. In some embodiments, deflector ring 400 does not rotate relative to base 202 or baffle 300 when installed. In other embodiments, deflector ring 400 is rotatable to adjust the direction of the angular spray pattern while deflector ring 400 is installed. In yet further embodiments, deflector ring 400 may be configured to move between discreet angular positions (e.g., every 10 degrees, every 15 degrees, etc.) to provide indexed adjustment features for deflector ring 400.

In an assembled configuration, the grate 100 is installed within a drain system of an open room within a building. The grate 100 can interface with an existing drain or replace a section of the drain system. The third annular section 126 of the nozzle aperture 118 is provided with a seal. The base 202 of the nozzle 200 is inserted into the nozzle aperture 118 of the grate 100. The second grate step 108 interfaces with the flange 210 of the base 202. The second base step 222 may be provided with a seal to form a fluid seal between the base 202 and the grate 100. Deflector ring 400 may be provided on the flange 210 of the base 202. A spray outlet 404 of the deflector ring 400 is positioned to facilitate flow of fire suppression agent into the open room and towards a hazard. A seal may be provided with the deflector ring 400. The baffle 300 is positioned on the deflector ring 400 and the base 202. A fastener 500 is coupled to the baffle fastener aperture 306 of the baffle 300 and the central body 226 of the base 202. The fastener fixedly couples the baffle 300 to the base 202, and secures deflector ring 400 therebetween. Flow paths 213 are defined by contact between the flow protrusions 212 of the base 202 and the baffle 300. The deflector ring 400 prevents flow out of a portion of the flow paths 213 (i.e., prevents flow out of at least one of the flow paths 213). In some examples, the deflector ring 400 limits flow out of flow paths 213 to define a 90 degree spray angle. In other examples, the deflector ring 400 limits flow out of the flow paths 213 to define a 180 degree spray angle. In yet other examples, the deflector ring 400 is omitted to define a 360 degree spray angle. The deflector ring 400 may be structured to define other angles, for example an angle between 0 degrees and 360 degrees, according to various alternative embodiments. The fastener 500 may be loosened by top access to facilitate rotation or removal of the deflector ring 400 when in the assembled configuration. The deflector ring 400 may be rotated relative to the base axis X-X to change a direction of spray of the spray angle. At least one of the grate 100, the base 202, the baffle 300, and the deflector ring 400 may be manufactured from, for example, stainless steel, aluminum, etc.

In various embodiments, the flow protrusions 212 may be disposed on a bottom or nozzle-facing (i.e., facing the nozzle 200) surface of the baffle 300 (i.e., as an alternative or in addition to being disposed on the interior surface 211 of the nozzle 200. For example, the flow protrusions 212 may be circumferentially arranged along the nozzle-facing surface of the top 302 of the baffle 300 and oriented such the flow protrusions 212 extend radially outward from the baffle fastener aperture 306 to form flow paths 213 between each pair of adjacent flow protrusions 212. In various embodiments, the flow protrusions 212 may alternatively or additionally disposed on a bottom or nozzle-facing surface (i.e., facing the nozzle 200) of the bottom 304 of the baffle 300. In yet other embodiments, the flow protrusions 212 may be variably disposed along the nozzle-facing surface of the baffle 300 near the top 302 and/or bottom 304 of the baffle 300. In various embodiments, the flow protrusions 212 may be uniform in length, width, and shape. In other embodiments, at least one of the flow protrusions 212 or a subset of the flow protrusions 212 may have at least one of a different length, width, or shape as compared to at least another of the flow protrusions 212 or another subset of the flow protrusions 212.

In embodiments wherein one or more flow protrusions 212 are disposed along the bottom or nozzle-facing surface of the baffle 300, the annular body 402 of the deflector ring 400 may interface with the nozzle-facing surface of the top 302 of the baffle 300. Accordingly, the deflector ring 400 may be rotatably adjusted such that the spray outlet 404 is aligned with one or more flow paths 213 defined between flow protrusions 212 disposed on the baffle 300 and thus may control fluid flow from the nozzle 200 by allowing fluid flow from the flow paths 213 aligned with the spray outlet 404 and prevent flow from the flow paths 213 blocked by the annular body 402.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical, or other positioning or orientation descriptions include variations within +/−10% or +/−10 degrees of pure vertical, parallel, or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A grate assembly comprising:
a grate comprising a nozzle aperture; and
a nozzle received by the nozzle aperture, the nozzle comprising,
a base;
a baffle coupled to the base, wherein the base and the baffle define a plurality of flow paths; and
a deflector ring positioned between the baffle and the base, wherein the deflector ring includes a body that defines a spray outlet, wherein the body allows fluid flow through one or more flow paths aligned with the spray outlet and prevents fluid flow through the remaining flow paths.

2. The grate assembly of claim 1, wherein the spray outlet defines a spray angle of the nozzle.

3. The grate assembly of claim 2, wherein the spray angle is one of 90 degrees, 180 degrees, or 270 degrees.

4. The grate assembly of claim 1, wherein the nozzle is received at a top side of the grate, and wherein the deflector ring is replaceable when the nozzle is coupled to the grate by accessing only the top side of the grate.

5. The grate assembly of claim 4, wherein the deflector ring is moveable relative to a central axis of the nozzle when the nozzle is coupled to the grate by accessing a fastener on the top side of the baffle.

6. The grate assembly of claim 1, wherein the base comprises a plurality of flow protrusions, the plurality of flow protrusions defining the plurality of flow paths.

7. The grate assembly of claim 6, wherein the plurality of flow protrusions are spaced about a circumference of the base.

8. The grate assembly of claim 1, wherein the deflector ring includes an annular projection received in an annular groove of the base.

9. A nozzle assembly comprising:
a base;
a baffle coupled to the base, wherein the base and the baffle define a plurality of flow paths; and
a deflector ring positioned between the baffle and the base, wherein the deflector ring includes a body that defines a spray outlet, wherein the body allows fluid flow through one or more flow paths aligned with the spray outlet and prevents fluid flow through the remaining flow paths.

10. The nozzle assembly of claim 9, wherein the spray outlet defines a spray angle.

11. The nozzle assembly of claim 10, wherein the spray angle is one of 90 degrees, 180 degrees, or 270 degrees.

12. The nozzle assembly of claim 9, wherein the deflector ring is replaceable by accessing only a top side of the nozzle assembly.

13. The nozzle assembly of claim 12, wherein the deflector ring is moveable relative to a central axis by accessing a fastener on the top side of the nozzle assembly.

14. The nozzle assembly of claim 9, wherein the base comprises a plurality of flow protrusions, the plurality of flow protrusions defining the plurality of flow paths.

15. The nozzle assembly of claim 14, wherein the plurality of flow protrusions are spaced about a circumference of the base.

16. The nozzle assembly of claim 9, wherein the deflector ring includes an annular projection received in an annular groove of the base.

17. A grate assembly kit comprising:
a grate defining a nozzle aperture;
a nozzle configured to be positioned within the nozzle aperture; and
a plurality of deflector rings, each removably and individually positionable within the nozzle;
wherein each deflector ring of the plurality of deflector rings comprises a body that defines a spray outlet, and wherein the body allows fluid flow through a first subset of the plurality of flow paths and prevents fluid flow through a second subset of the plurality of flow paths.

18. The grate assembly kit of claim 17, wherein the plurality of deflector rings comprises a first deflector ring configured to provide a 90 degree spray pattern and a second deflector ring configured to provide a 180 degree spray pattern.

19. The grate assembly kit of claim 17, wherein the nozzle comprises a base and a baffle coupled to the base, the base and the baffle defining a plurality of flow paths.

20. The grate assembly kit of claim 19, wherein each deflector ring prevents fluid flow through at least one flow path of the plurality of flow paths to provide the spray pattern for the nozzle.
